(19) United States
(12) Patent Application Publication
(10) Pub. No.: US 2007/0142055 A1
(43) Pub. Date: Jun. 21, 2007

(54) Method, mobile device and computer program product for automatically fetching local area radio channels

(75) Inventors: Sanna Toivanen, Tampere (FI); Tero Laiho, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/313,475

(22) Filed: Dec. 21, 2005

(51) Int. Cl. H04Q 7/20

(52) U.S. Cl. 455/450; 455/509; 370/329

(57) ABSTRACT

A method, mobile device and computer program product are provided for automatically determining the frequencies of one or more radio stations available in the location in which a user (and, therefore, his or her mobile device) is located and presetting those frequencies to the mobile device. In addition, a means by which the user can automatically continue listening to the same radio station (e.g., KISS FM) using a different radio frequency channel associated with that station, as he or she travels and the radio frequency channel to which he or she is currently tuned becomes weak is also provided.

### FIELD OF THE INVENTION

Exemplary embodiments of the present invention relate generally to mobile devices having AM/FM radio capabilities and, more particularly, to improving the experience of users of such mobile devices.

### BACKGROUND OF THE INVENTION

Currently, users of mobile devices having AM/FM radio capabilities, such as the Nokia 7710 Widescreen Smartphone with an FM Visual Radio, are forced to manually scan through all of the available radio frequencies in order to find radio stations that are available in the area in which they are currently located. This process can be somewhat burdensome and frustrating, particularly where the users of these mobile devices are frequent travelers.

One alternative that has been provided is the introduction of a Station Directory Service. This service enables the user to manually access a database that provides a list of each of the available radio channels in a particular area. This service, however, has several limitations; the primary limitation being the fact that a user must manually enter in the name of the city in which he or she is located in order to download information regarding radio stations in that city. This too, therefore, can be quite burdensome, particularly where, for instance, the user is in his or her car traveling quickly from one city to the next. The user may not be aware of the name of the city in which he or she is located, or he or she may not know the correct spelling of that city (e.g., Willacoochee or Hopeulikit, Ga.), especially where traveling abroad when unfamiliar with the area and the language.

A need, therefore, exists for a means by which the burden placed on users of mobile devices having AM/FM radio capabilities can be alleviated.

### BRIEF SUMMARY OF THE INVENTION

In general, exemplary embodiments of the present invention provide an improvement over the known prior art by, among other things, providing a method of automatically determining the frequencies of one or more radio stations available in the location in which the user (and, therefore, his or her mobile device) is located and presetting those frequencies to the mobile device. In addition, exemplary embodiments of the present invention provide a means by which the user can automatically continue listening to the same radio station (e.g., KISS FM) using a different radio frequency channel associated with that station, as he or she travels and the radio frequency channel to which he or she is currently tuned becomes weak.

According to one exemplary aspect of the present invention a method is provided of automatically determining and storing one or more local radio channels to a mobile device. In one exemplary embodiment, the method includes: (1) determining a geographic location associated with the mobile device; (2) providing the geographic location such that one or more local radio channels corresponding to the geographic location are determinable; and (3) storing one or more radio frequencies associated with respective local radio channels on the mobile device.

In one exemplary embodiment, determining a geographic location associated with the mobile device includes determining at least one of a Mobile Country Code, Mobile Network Code, Location Area Code, or Cell ID associated with the mobile device. Alternatively, in another exemplary embodiment, it may include determining a latitude and longitude value associated with the geographic location.

In one exemplary embodiment, the method further includes accessing a database that stores a mapping of geographic locations to one or more radio channels available in respective locations to determine one or more local radio channels. Alternatively, in another exemplary embodiment the method further includes transmitting a request for information regarding local radio channels to a network entity responsible for providing the information to determine one or more local radio channels.

The method of another exemplary embodiment further includes tuning the mobile device to a current radio channel, determining whether one of the local radio channels comprises a radio station name equivalent to the radio station name associated with the current radio channel, and automatically tuning the mobile device to the local radio channel having an equivalent radio station name upon a determination that such a local radio channel exists.

According to another aspect of the present invention, a mobile device capable of automatically determining and storing one or more local radio channels is provided. In one exemplary embodiment the mobile device includes a processor and a memory in communication with the processor that stores an application executable by the processor The application of one exemplary embodiment is capable, upon execution, of: (1) determining a geographic location associated with the mobile device; (2) providing the geographic location such that one or more local radio channels associated with the geographic location are determinable; and (3) storing one or more radio frequencies corresponding to the local radio channels on the mobile device.

According to yet another aspect of the present invention, a computer program product is provided for automatically determining and storing one or more local radio channels to a mobile device. In one exemplary embodiment, the computer program product includes at least one computer-readable storage medium having computer-readable program code portions stored therein. These computer-readable program code portions may include: (1) a first executable portion for determining a geographic location associated with the mobile device; (2) a second executable portion for providing the geographic location such that one or more local radio channels corresponding to the geographic location are determinable; and (3) a third executable portion for storing one or more radio frequencies associated with respective local radio channels on the mobile device.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of one type of system that would benefit from exemplary embodiments of the present invention;

FIG. 2 is a schematic block diagram of an entity capable of operating as a Station Directory Service Server in accordance with exemplary embodiments of the present invention;

FIG. 3 is a schematic block diagram of a mobile station capable of operating in accordance with an exemplary embodiment of the present invention;

FIG. 4 is a flow chart illustrating the steps which may be taken in order to automatically determine and store local area radio channels to a mobile device in accordance with an exemplary embodiment of the present invention; and

FIG. 5 is a flow chart illustrating a method of maintaining a current radio station while traveling in accordance with an exemplary embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

Exemplary embodiments of the present invention provide a technique for automatically determining the local radio channels available to a user and storing the radio station name and radio frequency associated with those channels to the user's mobile device, so that he or she need only press a button to listen to a radio station regardless of where he or she is located. In general, the mobile device, which may be, for example, a cellular telephone, personal digital assistant (PDA), laptop, or even an FM radio incorporated into a motor vehicle having wireless communications capabilities, which may use one of various means, including a Global Positioning System (GPS), to determine its geographic location. The location information may be in the form of latitude and longitude coordinates, for example, or various country, network and area codes. Using this information, the mobile device can automatically determine which radio channels are available in that area, without requiring that the user manually request such information. This may be done, for example, by accessing a database that stores a mapping of various geographic locations to the radio channels available in that location. Finally, the mobile device will automatically populate certain memory fields in the mobile device with the radio frequencies corresponding to the local radio channels. Each memory field, in turn, may be associated with a particular input key of the mobile device (e.g., a soft key on the mobile device key pad or a key displayed on a touch screen), such that when the input key is depressed, or otherwise actuated, by the user, the mobile device will automatically tune to the radio frequency stored in the corresponding memory field.

Several different events may trigger the mobile device to perform the above-described steps. For example, the mobile device may determine the local radio channels each time the device is turned on and/or on a periodic basis while the device remains powered on. Alternatively, or in addition, the mobile device may do so each time the device moves into a different cell of a cellular network or where it determines that new channels have become available. In another exemplary embodiment, the mobile device may monitor the strength of the radio channels currently being used by the device to access a particular radio station and perform the above steps when it is determined that the channel is becoming weak. In this instance, another feature of exemplary embodiments of the present invention is that the mobile device may determine which radio station is associated with the radio channel in use and then determine whether one of the stronger, local radio channels is likewise associated with that radio station. The mobile device can then automatically retune the mobile device to the local radio channel associated with the radio station enabling the listener to continue listening to the same radio station as he or she travels, despite the fact that the radio channel he or she was originally using became weak.

Overall System and Relevant Components:

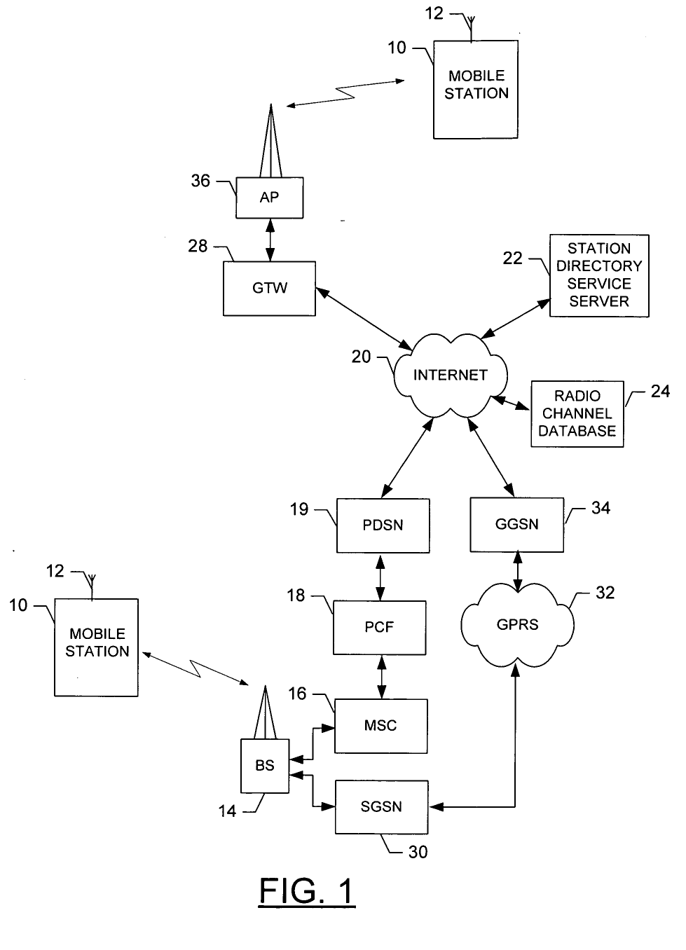

Referring to FIG. 1, an illustration of one type of system that would benefit from the present invention is provided. As shown in FIG. 1, the system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include a Station Directory Service Server 22 and/or a Radio Channel Database 24, discussed below. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements (e.g., Station Directory Service Server 22 and/or Radio Channel Database 24) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the mobile stations 10 to one or more processing elements (e.g., a server associated with a Station Directory Service 22 and/or Radio Channel Database 24) across the Internet 20, one or more such entities may be directly coupled to one another. As such, one or more network entities may communicate with one another in accordance with, for example, RF, BT, IRDA or any of a number of different wireline or wireless communication techniques, including LAN and/or WLAN techniques. Further, the mobile station 10 and the processing elements can be coupled to one or more electronic devices, such as printers, digital projectors and/or other multimedia capturing, producing and/or storing devices (e.g., other terminals).

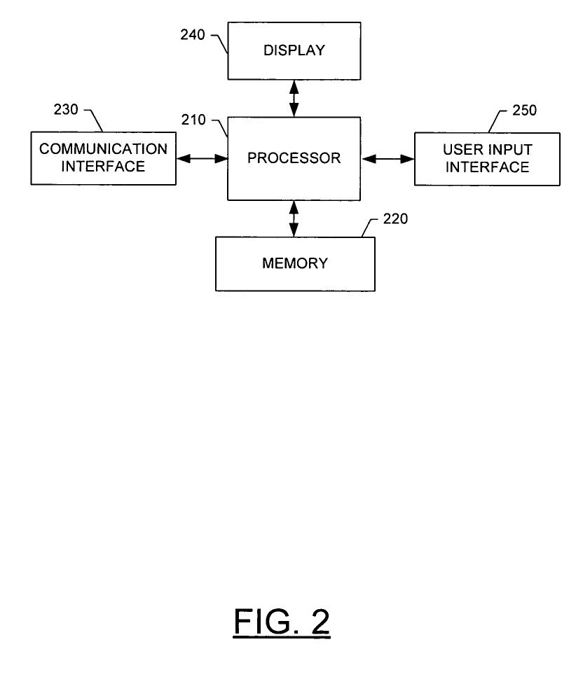

Referring now to FIG. 2, a block diagram of an entity capable of operating as a Station Directory Service Server 22 is shown in accordance with one embodiment of the present invention. The entity capable of operating as a Station Directory Service Server 22 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a Station Directory Service Server 22 can generally include means, such as a processor 210 connected to a memory 220, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

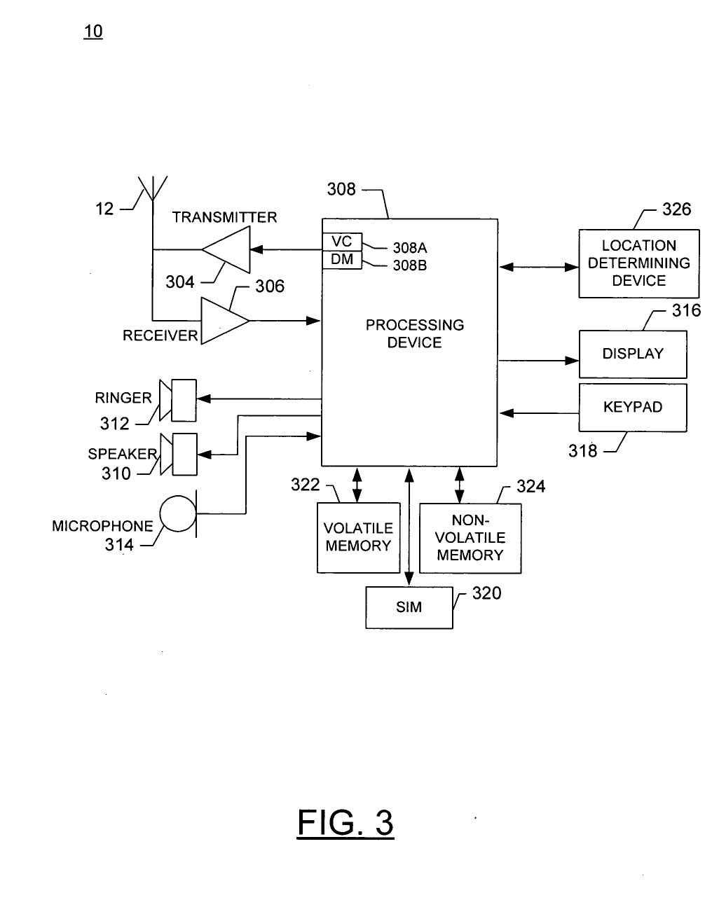

Reference is now made to FIG. 3, which illustrates one type of mobile device that would benefit from embodiments of the present invention. As shown, the mobile device may be a mobile station 10, and, in particular, a cellular telephone. It should be understood, however, that the mobile station illustrated and hereinafter described is merely illustrative of one type of mobile device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, including, for example FM radios carried by certain motor vehicles having GPS and other wireless communications capabilities, can readily employ embodiments of the present invention.

The mobile station includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, in addition to an antenna 12, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for determining a geographic location associated with the mobile station. For this purpose, in one exemplary embodiment, the mobile station may further comprise a location determining device 326, such as a GPS receiver, for determining, for example, latitude and longitude values representing the mobile station's location. The memory may further store computer program code for, determining one or more local radio channels corresponding to the geographic location, and storing the radio frequencies associated with those local radio channels.

As discussed herein, the memory may further include one or more memory fields that store respective radio frequencies. These fields may correspond with respective keys of the key pad 318 or of a touch screen, such that when the user depresses, or otherwise actuates, one of the keys, the mobile device will be tuned to the radio frequency corresponding to that key for the purpose of broadcasting the radio station associated with that radio frequency.

Method of Automatically Fetching Local Area Radio Channels:

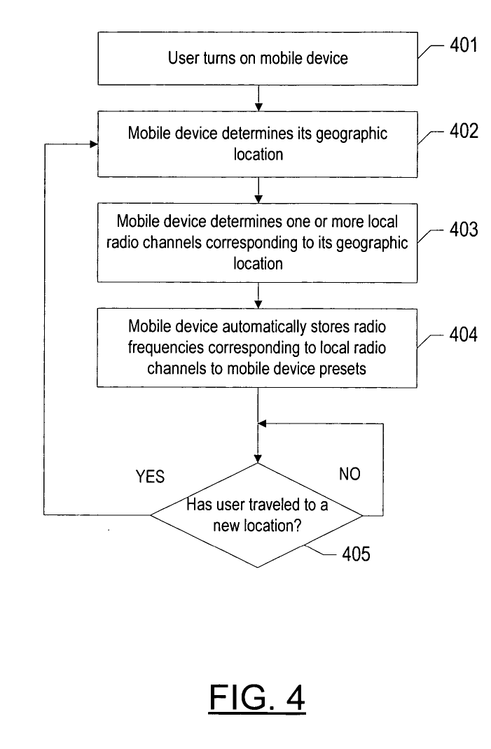

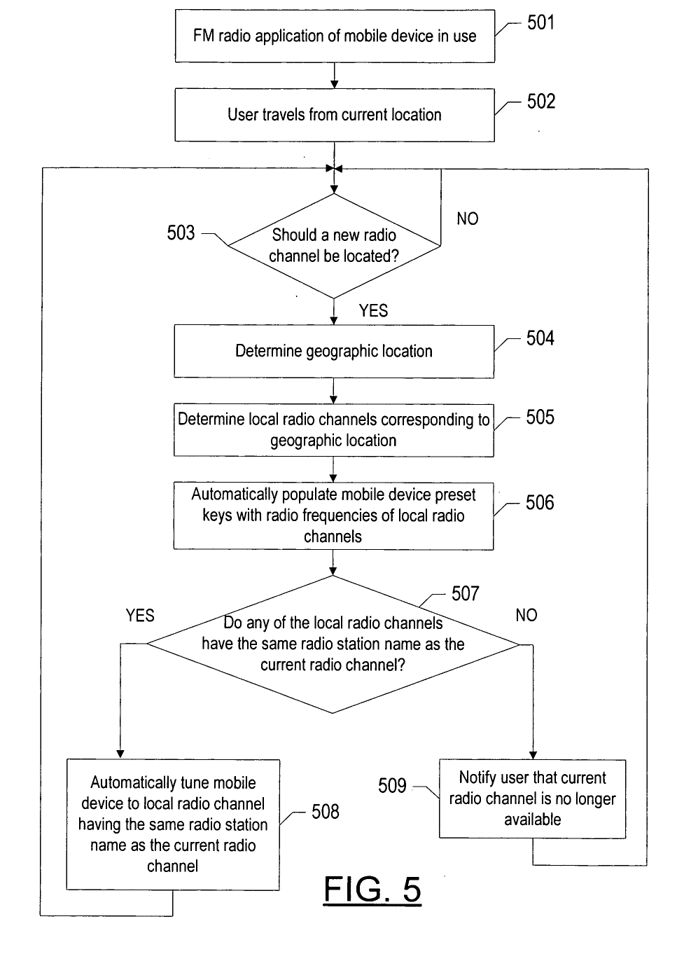

Reference is now made to FIG. 4, which illustrates the steps which may be taken in order to automatically determine and store local radio channels to a mobile device in accordance with exemplary embodiments of the present invention. As shown, the process may begin at Step 401, where the user first turns on his or her mobile device. As mentioned above, and as is discussed in more detail below with respect to FIG. 5, the following steps may likewise occur as a result of other triggers, such as when the mobile device moves from one cell of a cellular network to another, or on a periodic or other repeated basis.

Regardless of the trigger, in Step 402, the mobile device automatically determines its geographic location. In one exemplary embodiment, the mobile device comprises a Global System for Mobile Communications (GSM) phone. In this embodiment, one method of determining the geographic location of the mobile device is to scan the GSM network for location information in the form of a Mobile Country Code (MCC), Mobile Network Code (MNC), Location Area Code (LAC) and Cell ID. As will be understood by those of ordinary skill in the art, other wireless networks and corresponding protocols, such as CDMA, GPRS, EDGE or UMTS, to name a few, may similarly be used to gather such geographic location information. In other exemplary embodiments, the mobile device may include a Global Positioning System (GPS) receiver that is capable of receiving geographic location information in the form of latitude and longitude coordinates. As will be understood by those of skill in the art, these are just two examples of means by which the mobile device can determine its geographic location, and other such means may be used without departing from the spirit and scope of the present invention.

Once the mobile device has determined its geographic location, the mobile device automatically determines which radio channels are available in that location (Step 403). In one exemplary embodiment, this is done by accessing a Station Directory Service, for example using an Hypertext Markup Language (HTML) or Website Meta Language (WML) browser, to obtain the radio station name and radio frequency of all radio channels available in the geographic location. As mentioned above, the Station Directory Service is a service currently available to users of mobile devices having FM Visual Radio. In response to receiving a request from the user, the currently available Station Directory Service provides a listing of radio channels in the form shown in Table 1 below.

TABLE 1
Exemplary Station Directory Service

| Radio Station | | | |
|---|---|---|---|
| Name/Call Sign | Frequency | City | State |
| KISS FM | 92.9 | Tallahassee | Florida |
| The Fish | 105.7 | Atlanta | Georgia |
| Star 95.7 | 95.7 | Canberra | Australian Capital Territory |

As shown, when information regarding local radio channels is requested from the Station Directory Service (e.g., a request is transmitted to a server associated with the Station Directory Service), the current Station Directory Service provides the radio station names (e.g., KISS FM) and corresponding radio frequencies (e.g., 92.9 FM) for a particular city and state (e.g., Tallahassee, Fla.). As discussed above, however, the geographic location known by the mobile device may be in the form of an MCC, MNC, LAC and Cell ID, or latitude and longitude values. As a result, the step of determining which radio channels are available in a particular location may further involve converting the geographic location information known to the mobile device into, for example, a city and state name according to which the Station Directory Service associates radio channels. In one exemplary embodiment, this involves the mobile device accessing a database that provides a mapping of, for example, each Cell ID or set of latitude and longitude coordinates to a particular city and state. Alternatively, in one exemplary embodiment, an enhanced Station Directory Service, may be available, wherein either the Station Directory Service server is capable of performing the necessary conversion of the geographic location information received into the appropriate form (e.g., a city name), or the database actually accessed by the Station Directory Service includes, not only city and state names, but also other forms of geographic location information (e.g., latitude and longitude coordinates).

In another exemplary embodiment, the mobile device itself may access a database, such as a Radio Channel Database, which provides the mapping of available radio stations directly to the geographic location information known to the mobile device (i.e., sidestepping the server associated with the Station Directory Service).

Finally, in Step 404, the mobile device automatically stores the radio frequencies corresponding to the local radio channels to its presets. These radio frequencies are, thereafter, available to the user without the user having to search for them. In particular, in one exemplary embodiment, the memory of the mobile device may include a plurality of memory fields, each capable of storing a particular radio frequency. In one exemplary embodiment, each memory field corresponds to an input key of the mobile device key pad or displayed on the mobile device display screen, such that when the key is depressed, or otherwise actuated, the mobile device automatically tunes to the radio frequency stored in the corresponding memory field. These memory fields may further be capable of storing the radio station name associated with the radio frequency in that particular geographic location.

While not shown, the method may further include displaying the list of available radio channels to the user on the mobile station display screen, as well as optionally displaying the respective preset keys for each or at least some of the available radio channels. The list may include the radio station names as well as their radio frequencies. In this exemplary embodiment, in order to select a radio station from the list, the user may highlight the radio station name and/or radio frequency using his or her cursor, or merely touch the display screen in the vicinity of the radio station name and/or radio frequency using a pointer. Alternatively, the user could depress or otherwise actuate the key associated with a selected radio station.

At this point the mobile device will await an indication that the user has traveled to a new location (Step 405). In one exemplary embodiment, this may involve determining when the user has moved from one cell in a cellular network to another. Alternatively, or in addition, this may involve determining that the signal strength of the radio channel currently tuned to is below a predefined threshold. If the mobile device determines that the user has in fact moved to a new location, the process returns to Step 402, where the geographic location is determined, the corresponding local radio channels are further determined, and the radio frequencies of those channels are stored to the mobile device. Where the user has not traveled to a new location, the mobile device will, in one exemplary embodiment, continue checking until the use does travel or the device is turned off. Alternatively, in another exemplary embodiment, not shown, the mobile device may periodically repeat Steps 402-404 in order to update the local radio channels regardless of whether or not it determines that the user has traveled.

In one exemplary embodiment, the user may turn on or off the service described above. In other words, the user may specify that he or she does not want the mobile device to automatically scan for local radio channels and save those channels to the device. In addition, in another exemplary embodiment, the user may specify that only certain presets (i.e., memory fields earmarked for radio frequencies) should be used for saving local radio channels located by the mobile device. This allows the user to maintain his or her hometown radio stations saved to his or her mobile device at all times. Alternatively, a default set of presets (radio channels associated with respective keys) could be stored and could be recalled by a user irrespective of the radio channels that have been identified and stored by the service described above. As such, a user could travel, for example, away from their hometown with the mobile device automatically identifying the available radio channels in the manner described above while the user is traveling. Upon returning home, the user could provide an input, either via a predefined key sequence or in any other manner, indicating that the default set of presets should be restored, thereby sparing the user from having to select from among the radio channels that are automatically found to be available upon returning home.

Reference is now made to FIG. 5 which illustrates an additional feature of exemplary embodiments of the present invention. In particular, FIG. 5 illustrates the steps which may be taken in order to enable a user to continue listening to the same radio station while traveling, despite the fact that the radio channel on which he or she is listening becomes weak. As shown, the process begins at Step 501 where the user is currently using the FM radio application of his or her mobile device (i.e., the user is listening to the radio). While listening to a particular radio station, the user travels, at Step 502, from his or her current location. In Step 503, the mobile device determines whether a new, local radio channel should be located. As mentioned above, the mobile device may determine that each time the mobile device moves from one cell of a cellular network to another, local radio channels should be located. Alternatively, or in addition, the mobile device may periodically monitor the strength of the current radio channel and determine that once the strength of the signal is below a certain threshold, that local radio channels should be found.

If it is determined that it is not time to locate local radio channels, the process will continue waiting until it is time or the mobile device is turned off. Alternatively, if it is determined that local radio channels should be found, the process continues to Steps 504 through 506, which are equivalent to Steps 402 though 404 discussed above with respect to FIG. 4. In particular, the mobile device determines its geographic location, uses the geographic location information to determine local radio channels, and stores the radio frequencies associated with those local radio channels to the mobile device.

At this point, the mobile device will look to see if it is possible to allow the user to continue listening to the same radio station. In particular, in Step 507, the mobile device will determine whether any of the local radio channels have the same radio station name as the radio channel the user is current listening to. For example, where the user started in Tallahassee, Fla. listening to KISS FM on frequency 92.9 FM, and has now entered Monticello, Fla., the mobile device will determine if any of the local radio channels available in Monticello are associated with KISS FM (e.g., KISS FM at 102.5).

If a local radio channel exists having the same radio station name as the current radio channel, the mobile device will automatically, in Step 508, tune the mobile device to the frequency associated with that local radio channel. As a result, the user may not even be aware of the fact that he or she technically lost his or her station at some point during the user's travels. If no such radio channel exists, the mobile device, in Step 509, will notify the user in some way that the radio channel currently in use is no longer available. In one exemplary embodiment, the mobile device may automatically retune to the closest radio frequency. Alternatively, the mobile device may merely display the newly available radio channels and wait until the user selects one.

### CONCLUSION

As described above and as will be appreciated by one skilled in the art, embodiments of the present invention may be configured as a system, method, network entity or mobile device. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of automatically determining and storing one or more local radio channels to a mobile device comprising:
determining a geographic location associated with the mobile device;
providing the geographic location such that one or more local radio channels corresponding to the geographic location are determinable; and
storing one or more radio frequencies associated with respective local radio channels on the mobile device.

2. The method of claim 1, wherein determining a geographic location comprises determining at least one of a Mobile Country Code, Mobile Network Code, Location Area Code or Cell ID associated with the mobile device.

3. The method of claim 1, wherein determining a geographic location comprises determining a latitude and longitude value associated with the geographic location.

4. The method of claim 1 further comprising:
accessing a database that stores a mapping of geographic locations to one or more radio channels available in respective locations to determine one or more local radio channels.

5. The method of claim 4, wherein the database stores a radio frequency and a radio station name corresponding to each radio channel, and wherein storing a radio frequency associated with respective local radio channels further comprises storing the radio station name also associated with the radio channel.

6. The method of claim 5 further comprising:
tuning the mobile device to a current radio channel;
determining whether one of the local radio channels comprises a radio station name equivalent to the radio station name associated with the current radio channel; and
automatically tuning the mobile device to the local radio channel having an equivalent radio station name upon a determination that such a local radio channel exists.

7. The method of claim 4, wherein the geographic locations stored in the database comprise city names, and wherein the method further comprises:
determining a city name corresponding to the geographic location associated with the mobile device, wherein determining one or more local radio channels comprises determining one or more local radio channels corresponding to the city name.

8. The method of claim 1 further comprising:
transmitting a request for information regarding local radio channels to a network entity responsible for providing the information to determine one or more local radio channels.

9. The method of claim 1, further comprising determining that the mobile device has entered a different cell and thereafter performing the steps of determining the geographic location, providing the geographic location and storing one or more radio frequencies.

10. The method of claim 1, further comprising determining a signal strength of the radio channel currently tuned to by the mobile device is less than a predefined threshold, and thereafter performing the steps of determining the geographic location, providing the geographic location, and storing one or more radio frequencies.

11. A mobile device capable of automatically determining and storing one or more local radio channels comprising:
a processor;
a memory in communication with the processor, said memory storing an application executable by the processor, the application capable, upon execution, of:
determining a geographic location associated with the mobile device;
providing the geographic location such that one or more local radio channels associated with the geographic location are determinable; and
storing one or more radio frequencies corresponding to the local radio channels on the mobile device.

12. The mobile device of claim 11, wherein determining a geographic location associated with the mobile device comprises determining at least one of a Mobile Country Code, Mobile Network Code, Location Area Code or Cell ID associated with the mobile device.

13. The mobile device of claim 11 further comprising:
a Global Positioning System (GPS) receiver capable of determining a latitude and longitude value associated with the geographic location.

14. The mobile device of claim 11, wherein said application is further capable, upon execution, of accessing a database that stores a mapping of geographic locations to one or more radio channels available in respective locations in order to determine the one or more local radio channels.

15. The mobile device of claim 14, wherein the database stores a radio frequency and a radio station name corresponding to each radio channel, and wherein the application is further capable, upon execution of storing the radio station name associated with the local radio channels.

16. The mobile device of claim 15 further comprising:
a display in communication with the processor, wherein the application is further capable, upon execution, of displaying the radio station names and radio frequencies associated with the local radio channels on the display.

17. The mobile device of claim 15, wherein the application is further capable, upon execution, of:
tuning the mobile device to a current radio channel;
determining whether one of the local radio channels comprises a radio station name equivalent to the radio station name associated with the current radio channel; and
automatically tuning the mobile device to the local radio channel having an equivalent radio station name upon a determining that such a local radio channel exists.

18. The mobile device of claim 14, wherein the geographic locations stored in the database comprise city names.

19. The mobile device of claim 18, wherein the application is further capable, upon execution, of determining a city name corresponding to the geographic location associated with the mobile device, wherein determining one or more local radio channels comprises determining one or more local radio channels corresponding to the city name.

20. The mobile device of claim 11, wherein the application is further capable, upon execution, of transmitting a request for information regarding local radio channels to a network entity responsible for providing the information to determine one or more local radio channels.

21. The mobile device of claim 11, wherein the application is further capable, upon execution, of determining that the mobile device has entered a different cell and thereafter performing the steps of determining the geographic location, providing the geographic location and storing one or more radio frequencies.

22. The mobile device of claim 11, wherein the application is further capable, upon execution, of automatically performing the steps of determining the geographic location, providing the geographic location and storing one or more radio frequencies, when the mobile device is first turned on.

23. The mobile device of claim 11, wherein the application is further capable, upon execution, of determining a signal strength of the radio channel currently tuned to by the mobile device is less than a predefined threshold, and thereafter performing the steps of determining the geographic location, providing the geographic location, and storing one or more radio frequencies.

24. The mobile device of claim 11, wherein the memory further comprises a plurality of memory fields, one or more of said fields storing the radio frequencies corresponding to the local radio channels, said mobile device further comprising:
an input device comprising a plurality of keys, one or more of the keys associated with respective memory fields, such that when the key is actuated, the mobile device is capable of tuning to the radio frequency stored in the corresponding memory field.

25. A computer program product for automatically determining and storing one or more local radio channels to a mobile device, wherein the computer program product comprises at least one computer-readable storage medium having computer-readable program code portions stored therein, the computer-readable program code portions comprising:
a first executable portion for determining a geographic location associated with the mobile device;
a second executable portion for providing the geographic location such that one or more local radio channels corresponding to the geographic location are determinable;
a third executable portion for storing one or more radio frequencies associated with respective local radio channels on the mobile device.

26. The computer program product of claim 25, wherein determining a geographic location comprises determining at least one of a Mobile Country Code, Mobile Network Code, Location Area Code or Cell ID associated with the mobile device.

27. The computer program product of claim 25, wherein determining a geographic location comprises determining a latitude and longitude value associated with the geographic location.

28. The computer program product of claim 25 further comprising:
a fourth executable portion for accessing a database that stores a mapping of geographic locations to one or more radio channels available in respective locations to determine one or more local radio channels.

29. The computer program product of claim 28, wherein the database stores a radio frequency and a radio station name corresponding to each radio channel, and wherein the third executable portion is capable of storing the radio station name also associated with the radio channel.

30. The computer program product of claim 29 further comprising:
a fifth executable portion for tuning the mobile device to a current radio channel;
a sixth executable portion for determining whether one of the local radio channels comprises a radio station name equivalent to the radio station name associated with the current radio channel; and
a seventh executable portion for automatically tuning the mobile device to the local radio channel having an equivalent radio station name upon a determination that such a local radio channel exists.

31. The computer program product of claim 28, wherein the geographic locations stored in the database comprise city names, and wherein the computer program product further comprises:
a fifth executable portion for determining a city name corresponding to the geographic location associated with the mobile device, wherein determining one or more local radio channels comprises determining one or more local radio channels corresponding to the city name.

32. The computer program product of claim 25 further comprising:
a fourth executable portion for transmitting a request for information regarding local radio channels to a network entity responsible for providing the information to determine one or more local radio channels.

33. The computer program product of claim 25 further comprising:
a fourth executable portion for determining that the mobile device has entered a different cell and thereafter performing the steps of determining the geographic location, providing the geographic location and storing one or more radio frequencies.

34. The computer program product of claim 25 further comprising:
a fourth executable portion for determining a signal strength of the radio channel currently tuned to by the mobile device is less than a predefined threshold, and thereafter performing the steps of determining the geographic location, providing the geographic location, and storing one or more radio frequencies.
